(19) United States
(12) Patent Application Publication
(10) Pub. No.: US 2018/0321825 A1
(43) Pub. Date: Nov. 8, 2018

(54) System and Method for Arranging Application Icons on a Mobile Device

(71) Applicant: MobileUX Technologies, Inc., Frisco, TX (US)

(72) Inventor: Rodrigo Martineli, Frisco, TX (US)

(73) Assignee: MobileUX Technologies, Inc., Frisco, TX (US)

(21) Appl. No.: 15/589,990

(22) Filed: May 8, 2017

(51) Int. Cl. G06F 3/0484; G06F 3/0481; G06F 3/0482; H04M 1/725

(52) U.S. Cl. CPC G06F 3/04845; H04M 1/72583; G06F 3/0482; G06F 3/04817

(57) ABSTRACT

A method for arranging application icons on a mobile device, including searching the mobile devices of one or more users for stored application icons and their associated screen numbers that they appear on the one or more users' mobile devices; presenting a first list of stored application icons and their associated screen numbers as they appear on the one or more users' mobile devices; receiving input from the one or more users to revise the screen number of one or more application icons to create a second list of stored application icons; and displaying the stored application icons on the one or more users' mobile devices according to the second list.

### TECHNICAL FIELD OF THE INVENTION

This invention relates, in general, to mobile device applications, and in particular, to a system and method for arranging application icons on a mobile device.

### BACKGROUND OF THE INVENTION

Without limiting the scope of the present invention, its background will be described in relation to a system and method for arranging application icons on a mobile device, as an example.

Arranging application icons on a mobile device can be problematic. For example, as with most mobile devices, moving an icon from a back page to a front page of a display of a mobile device requires the user to press and hold the icon to be moved. Then once all the application icons start “jiggling,” the user must attempt to drag the icon to the front page. This requires sideways movement of the target icon through any pages between the back page and the front page. Application icons slowly move out of the way and rearrange themselves. Ultimately, the user runs out of display screen to move the icon and must release the target icon locating it in a location that isn't the desired display location. Then the user must repeat the process again and again, even when the target icon has landed on the front page. This problem is compounded as the number of applications and their application icons are loaded onto a mobile device. For example, if a particular user has a mobile device with ten applications, then re-arranging the associated ten application icons is not that problematic. But when the user has two-hundred plus applications, then the above problem is hugely magnified.

Another problem with the above process is that when you finally do move a desired icon from a back screen to a home screen, all the other application icons must move to new locations to make room for the moved icon. This creates unfamiliar positions for application icons a user previously had familiarity in knowing its location.

Another known problem with today's mobile devices is that if there is an issue with software and the like and a user is instructed to reset the mobile device back to its original settings, most or all of the application icons and associated applications are deleted, never to be seen again. Even if the mobile device is backed up to the cloud, one or more of the applications may be infected and by simply uploading a backup will upload the problematic application and problems will persist.

Also, another problem may be that a particular user wishes to have the similar or the same application icons and locations of those application icons on their phone that are on other professionals, such as marketing professionals, medical professionals, athletes, investors, C-Suite executives, age, celebrities, demographics, racial, etc. This is not possible today. If an up and coming executive wishes to have the same application icons and arranged similarly to industry executives, there is no application currently that can accomplish this task.

### SUMMARY OF THE INVENTION

The present invention seeks to present and/or arrange on a display of a mobile device application icons as desired by a user in a more efficient manner.

The present invention disclosed herein is directed to a method for arranging application icons on a mobile device, including searching the mobile devices of one or more users for stored application icons and their associated screen numbers that appear on the one or more users' mobile devices; presenting a first list of stored application icons and their associated screen numbers as they appear on the one or more users' mobile devices; receiving input from the one or more users to revise the screen number of one or more application icons to create a second list of stored application icons; and displaying the stored application icons on the one or more users' mobile devices according to the second list.

In one aspect, the method may further include collecting the one or more user's age, name, location, profession, title, net worth, gender, and favorite hobbies for creating one or more application icon profiles of the one or more users. In another aspect, the method may include storing all the one or more application icon profiles for searching and uploading to the one or more users' mobile device. In yet another aspect, the method may include further searching the stored one or more application icon profiles according to a user's search criteria for selecting one or more of the application icon profiles.

The method may further include uploading the selected one or more of the application icon profiles to the user's mobile device.

In another embodiment, the present invention disclosed herein may be directed to a system for arranging application icons on a mobile device, including at least one processor; a memory connected to the at least one processor; and a module that when loaded into the at least one processor causes the at least one processor to search all applications, application icons, and the numbered screen on which they appear on the mobile device; list all applications, application icons, and their respective numbered screens; and accept input from a user to change the numbered screens on which the applications and application icons appear on the mobile device.

In one aspect, the module causes the at least one processor to display the applications and application icons according to their changed numbered screens. The system may include a transceiver for communicating with an external device. In still yet another aspect, the transceiver may be a wireless transceiver.

In another embodiment, the present invention disclosed herein may be directed to a method for arranging application icons on a mobile device, including searching the mobile device of one or more users for stored applications, associated icons, and their associated screen numbers as they appear on the one or more users' mobile devices; determining the frequency of use by the users of their stored applications and associated icons relative to their screen numbers; and displaying to the one or more users recommendations of those stored applications and associated icons that should be moved to a screen closer to a home page and those stored application icons that should be moved to a screen farther to a home page based on the frequency of use.

In one aspect, determining the frequency of usage includes calculating the percentage of the frequency of use of a stored application to the frequency of use of the stored applications. In another aspect, determining the frequency of usage includes determining the number of times the one or more users has opened the stored application. In yet another aspect, determining the frequency of usage includes determining the number of times the one or more users has opened the stored applications.

In still yet another aspect, determining the frequency of usage may include ranking the one or more stored applications based on the frequency of usage. Also, determining the frequency of usage includes displaying the one or more stored applications on relevant screens according to their frequency of usage.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 exemplifies four screen shots of a display of a mobile device depicting application icons according to an embodiment;

FIGS. 2A-2B are listings of application icons displayed in FIG. 1 according to an embodiment;

FIGS. 3A-3B are listings of application icons displayed in FIG. 4 according to an embodiment;

FIG. 4 exemplifies four screen shots of a display of a mobile device depicting application icons according to FIGS. 3A-3B according to an embodiment;

FIG. 5 is a block diagram of a mobile device according to an embodiment;

FIG. 6 is an illustration of a mobile device in a network environment according to an embodiment;

FIG. 7 is an illustration of a graphical user interface of a mobile device displaying data fields related to a particular user of the system according to an embodiment;

FIG. 8 is an illustration of a graphical user interface of a mobile device displaying command buttons of the present icon arranging system according to an embodiment;

FIG. 9 is a flowchart of a method for arranging application icons on a mobile device according to an embodiment;

FIG. 10 is a flowchart of a method for arranging application icons based on usage on a mobile device according to an embodiment; and

FIG. 11 is a flowchart of a method for uploading application icon profiles from other users to a users' mobile device according to an embodiment.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not limit the scope of the present invention.

Described herein are embodiments for a system and method for arranging application icons on a mobile device (hereinafter “icon arranging system”) and methods for detecting changes in a physical environment.

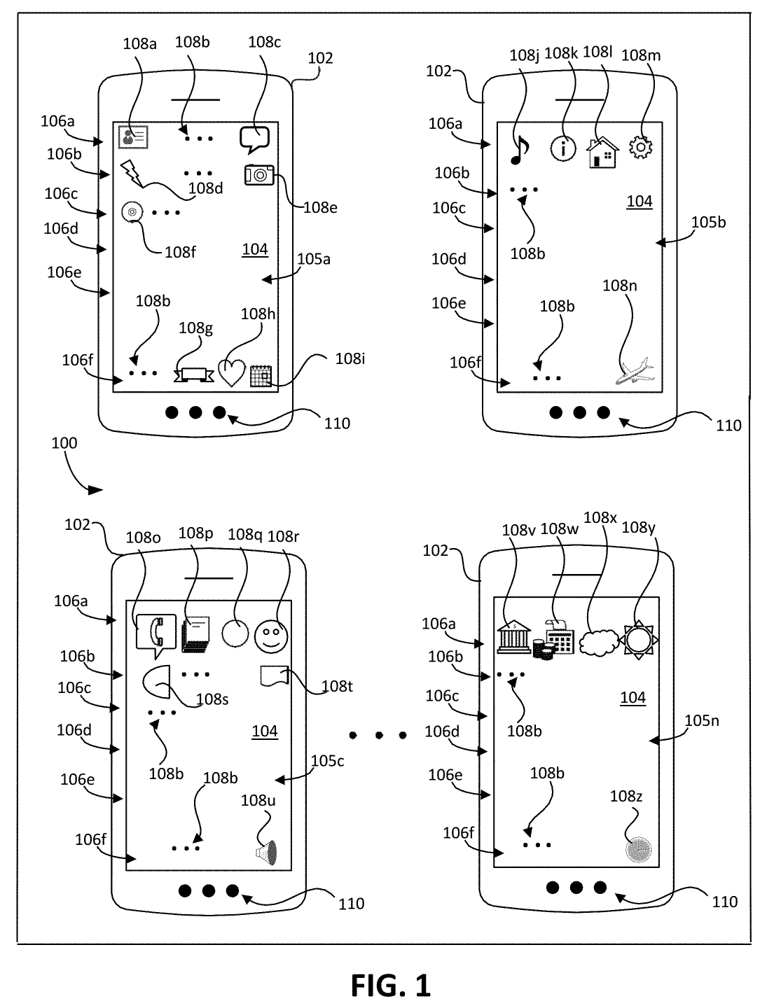

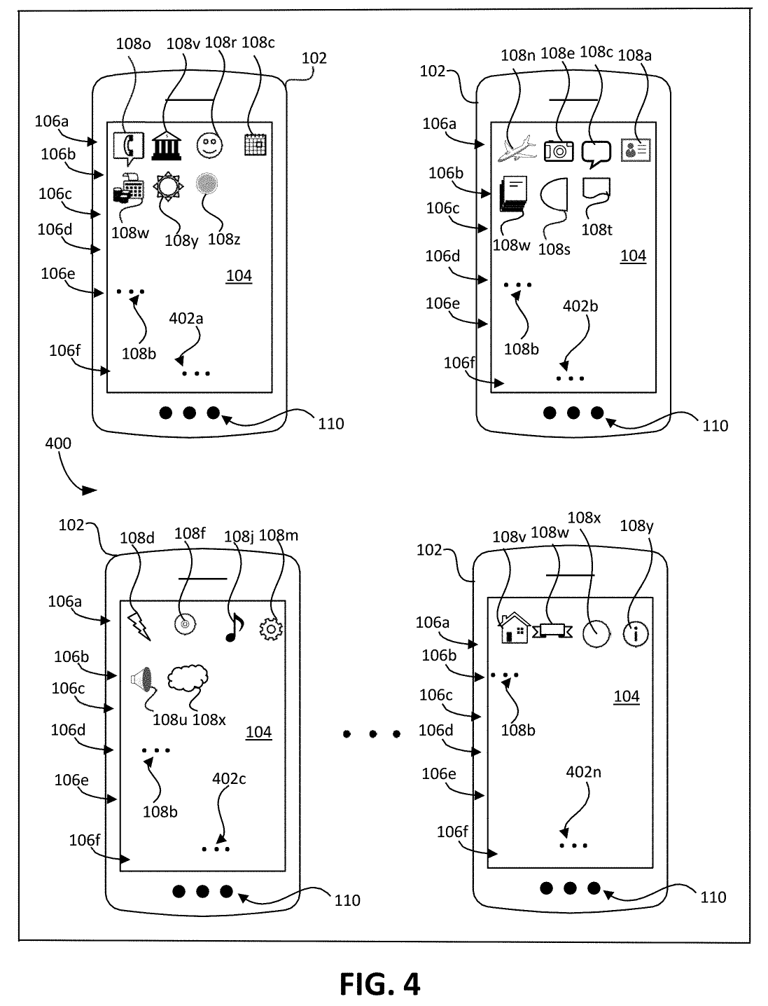

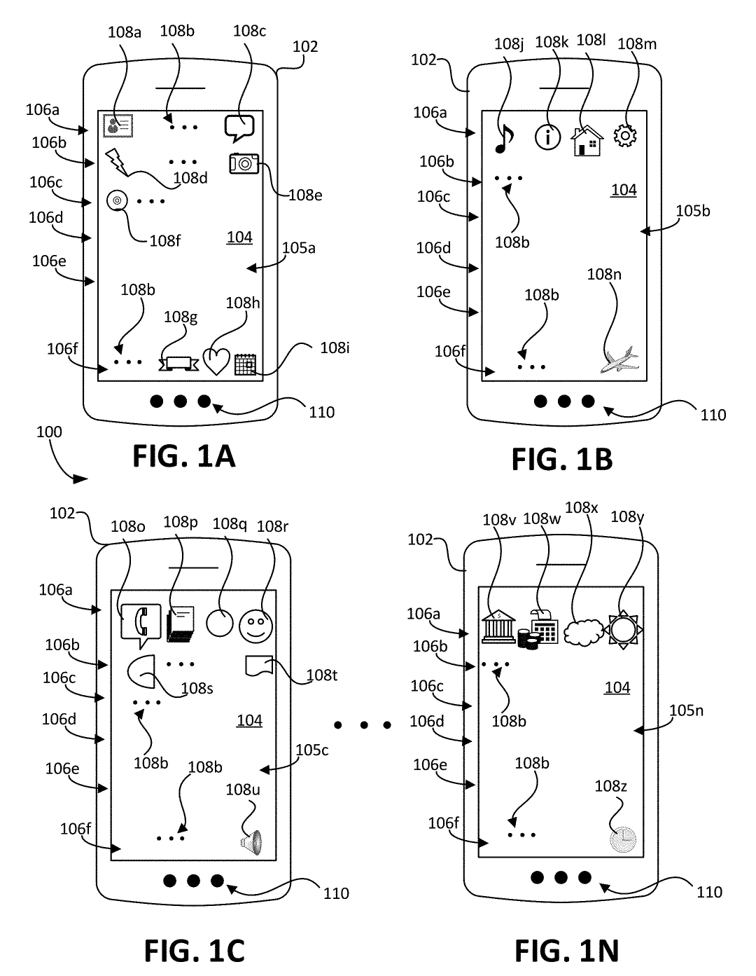

Referring initially to FIG. 1, an embodiment of an icon arranging system is illustrated and generally designated 100. Icon arranging system 100 may include a mobile device 102 having a visual display 104 for presenting a plurality of application icons to a user for selecting applications and the like to use by the user. Mobile device 102 may be any type of mobile device that displays application icons, such as application icons, to a user for selecting by the user. Some exemplary mobile devices 102 may include mobile phones, iPads, iPhones, Android mobile phones, Google mobile phones, Microsoft mobile phones, etc.

Display 104 of mobile device 102 may display a plurality of screens 105a-105n including one or more application icons arranged in rows and columns. With reference to FIG. 1, the first screen 105a of application icons displays a first row of application icons 106a of application icons 108 including contacts icon 108a, other application icons 108b, and a text icon 108c. As described herein, other application icons 108b may include any other application icons currently known but not listed or described in the present application. Ellipses are used to show that any other desired application icons are in the place where the ellipses are shown on mobile device 102. Although the screens of mobile device 102 are not completely full of application icons 108, the ellipses shown as other application icons 108b take the place of those application icons 108 not specifically shown, such that the screens described herein may be completely full and/or partially full of application icons 108.

The second row of application icons 106b includes a social media icon 108d, other application icons 108b, and a camera icon 108e. The third row of application icons 106c includes a stored music icon 108f and other application icons 108b. The fourth row of application icons 106d and fifth row of application icons 106e may be complete with second row of application icons 106b not specifically shown. A home row of application icons 106f may include a user's desired location for application icons 108. Home row of application icons 106f includes other application icons 108b, an awards icon 108g, a friends icon 108h, and a calendar icon 108i.

The second screen 105b includes first row of application icons 106a that includes a music icon 108j, an information icon 108k, a home icon 108l, and a settings icon 108m. Second screen 105b includes a second row of application icons 106b that includes other application icons 108b, for example. Second row of application icons 106b through fifth row of application icons 106e of second screen 105b includes other application icons 108b. Home row of application icons 106f of second screen 105b includes other application icons 108b and a flights icon 108n.

Third screen 105c includes first row of application icons 106a that include a call icon 108o, a books icon 108p, a notes icon 108q, and a personal development icon 108r, for example. Second row of application icons 106b includes a reminders icon 108s, other application icons 108b, and a documents icon 108t, for example. Third row of application icons 106c through fifth row of application icons 106e includes other application icons 108b and a sound icon 108u.

Any number of screens of application icons 108 may be displayed on mobile device 102, and the ellipsis between third screen 105c and fourth screen 105n is there to show that any number of screens 105 may be displayed on mobile device 102. With reference to fourth screen 105n, first row of application icons 106a includes a financial icon 108v, a banking icon 108w, a networks icon 108x, and a weather icon 108y, for example. Second row of application icons 106b through fifth row of application icons 106e may include other application icons 108b, for example. Home row of application icons 106f includes other application icons 108b and a clock icon 108z.

Icon arranging system 100 may include any number and type of application icons presently known or to be developed. The present invention is not limited by the present application icons available to mobile device users. First row of application icons 106a through home row of application icons 106f are collectively known as rows of application icons 106. Also, first screen 105a through fourth screen 105n are collectively known as screens 105. Additionally, although a certain number of rows, columns, and screens are shown, icon arranging system 100 may include any number of rows, columns, and screens of application icons on a mobile device as would be known to those skilled in the art.

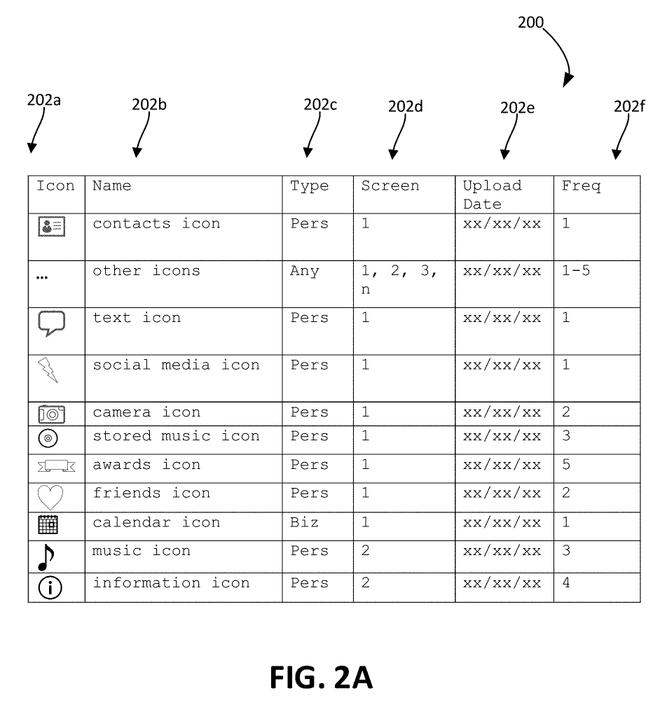

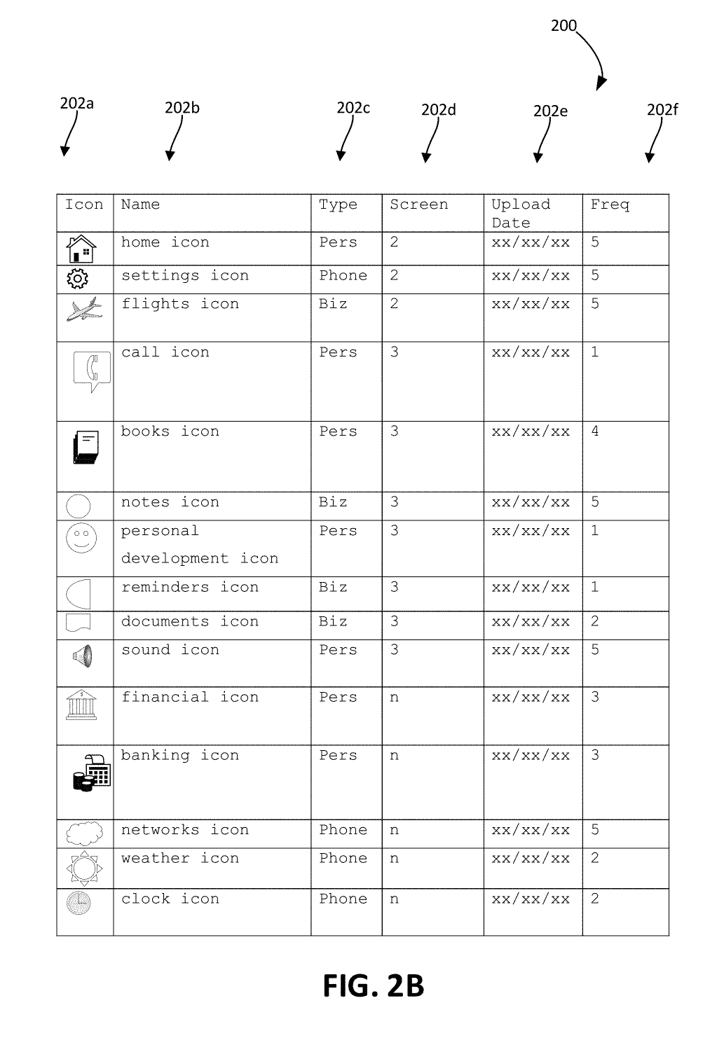

Turning now to FIGS. 2A-2B, an embodiment of icon arranging system 100 is shown and described. Icon arranging system 100 displays on visual display 104 of user's mobile device 102 a listing and/or database 200 of the current icon arrangement of the user's mobile device 102. For example, database 200 may include a plurality of rows and columns that reflect the current arrangement of application icons 108 as they are found in their respective rows or application icons 106 and screens 105.

In one embodiment, database 200 includes an icon column 202a, a name column 202b, a type column 202c, a screen column 202d, an upload date column 202e, and a frequency column 202f. The numbers in frequency column 202f may be provided by icon arranging system 100, in that at predetermined periods, icon arranging system 100 will run a report detailing the frequency of usage for each icon in the user's mobile device 102. This will assist the user in understanding which application icons 108 are more frequently used and thus give the user a guide for re-arranging their application icons. Icon arranging system 100 will make recommendations to a user that they should move or arrange more frequently used application icons 108 ahead of less used application icons 108, for example.

Additionally, icon arranging system 100 may make recommendations to remove those applications and their application icons 108 that are not being used frequently and that may be taking up valuable storage on mobile device 102. Some applications may not be removed due to proprietary rights from the manufacturer.

Icon arranging system 100 may include fewer or more columns and rows as shown, so those described herein are exemplary. Icon column 202a may display to a user those application icons as displayed on screens 105 of mobile device 102, for example. Additionally, name column 202b may display to a user those names associated with the application icons. Type column 202c may display to a user the type of application that is associated with a particular icon, such as personal, business, phone, etc. Screen column 202d may display to a user the particular screen 105 that a particular icon 108 is displayed on.

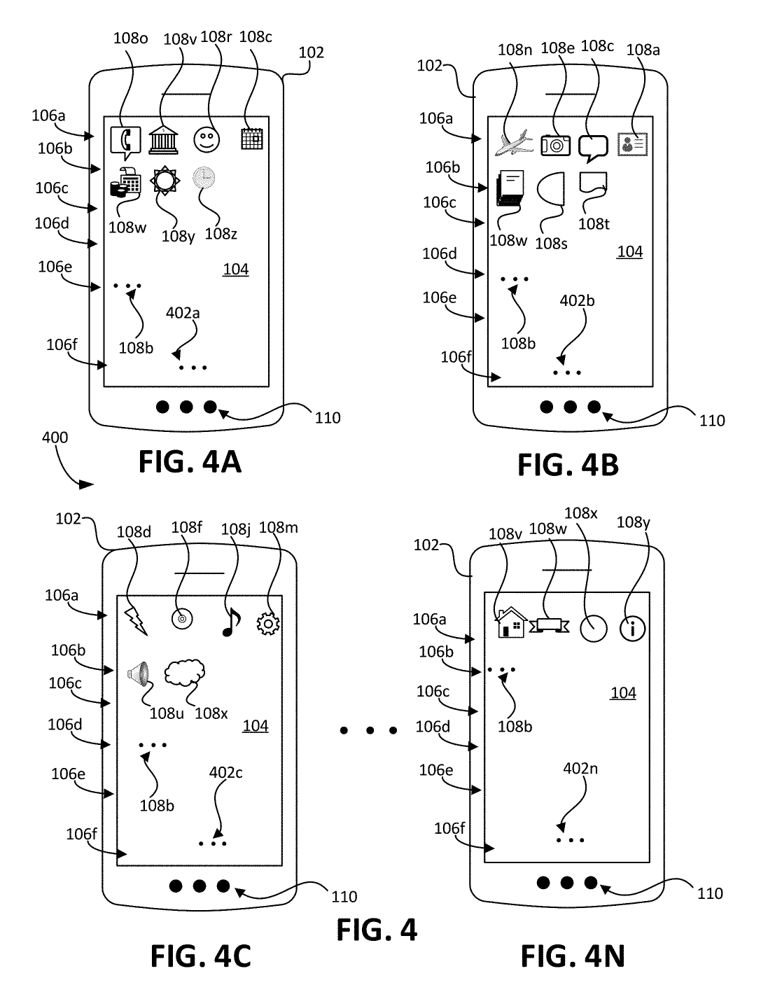

Further, database 200 of icon arranging system 100 may store in any of the external devices described herein all of application icons 108 for each user, such that should their mobile device 102 need to be completely reset, then all of application icons 108 in their stored database 200 can be uploaded again by icon arranging system 100 directing the user to an online store, such as iTunes, etc. Further, icon arranging system 100 may or may not include personal information as appropriate about a particular user and their icon profile. An icon profile may be a particular arrangement and type of application icons as shown in FIGS. 1 and 4.

With reference to FIGS. 1 and 2A-2B, contacts icon 108a is shown in first row of application icons 106a of visual display 104 of mobile device 102 and it is displayed in database 200 with a screen number 1, which means icon arranging system 100 has found contacts icon 108a on the first screen. Likewise with other application icons 108b, text icon 108c, social media icon 108d, camera icon 108e, stored music icon 108f, awards icon 108g, friends icon 108h, and calendar icon 108i, thus the number “1” in screen column 202d. Additionally, icon arranging system 100 has found and listed music icon 108j, information icon 108k, home icon 108l, settings icon 108m, other application icons 108b, and flights icon 108n on second screen 105b, thus the number “2” in screen column 202d. Similarly, icon arranging system 100 has found and listed call icon 108o, books icon 108p, notes icon 108q, personal development icon 108r, reminders icon 108s, other application icons 108b, documents icon 108t, and sound icon 108u on third screen 105c, thus the number “3” in screen column 202d. In the last screen shown, 105n, icon arranging system 100 has found and listed financial icon 108v, banking icon 108w, networks icon 108x, weather icon 108y, other application icons 108b, and clock icon 108z.

The above listed arrangement and location of application icons 108 is exemplary and do not limit the scope of the present invention. By simply presenting the user of mobile device 102 a database 200 of application icons 108 and on which screens 105 they are located, it gives the user an easy way in which to re-arrange them by simply either changing numbers in screen column 202d or by holding down and moving a particular icon 108 either up or down relative to the other found in database 200. Any other ways may be used to re-prioritize or re-arrange application icons 108 among screens 105. In one aspect, more than one database may be used by icon arranging system 100 such that a secondary or recovery database may not extract personal information from the primary database, such as for privacy concerns.

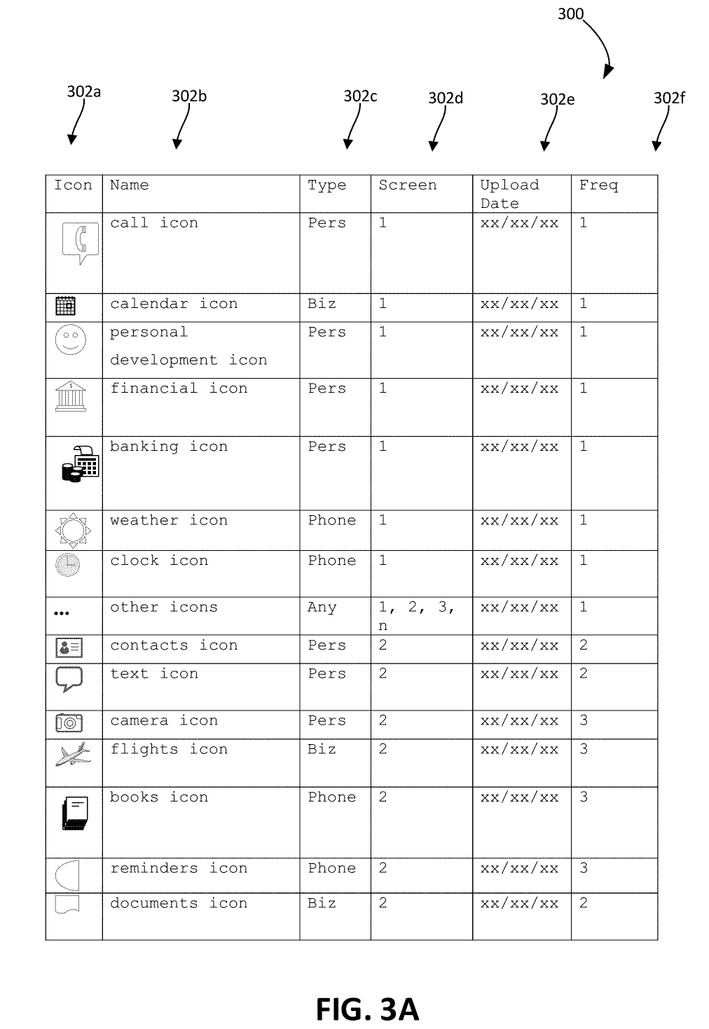

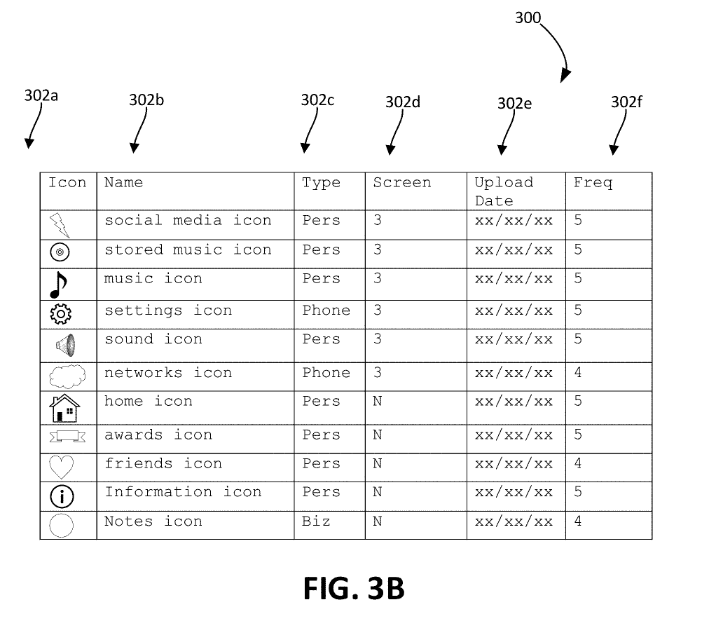

For example, with reference to FIGS. 3A-3B, a user of icon arranging system 100 has re-arranged the application icons to be in different locations from those shown in FIGS. 2A-2B by simply changing the screen number as shown in screen column 202d, for example. By simply changing the number “3” to number “1” in screen column 202d for call icon 108o, icon arranging system 100 now displays call icon 108o on first screen 105a of visual display 104 of mobile device 102. Similarly, all application icons 108 displayed on visual display 104 of mobile device 102 may be moved or arranged accordingly in such a simple manner. FIG. 4 displays the new arrangement of application icons by icon arranging system 100 through such an easy manner by just simply changing the value of the number in screen column 202d, in one embodiment.

Database 200 may be arranged according to a user's preferences, whether it's by application type, such as business, personal, games, sub-type games, alphabetical, download date, etc.

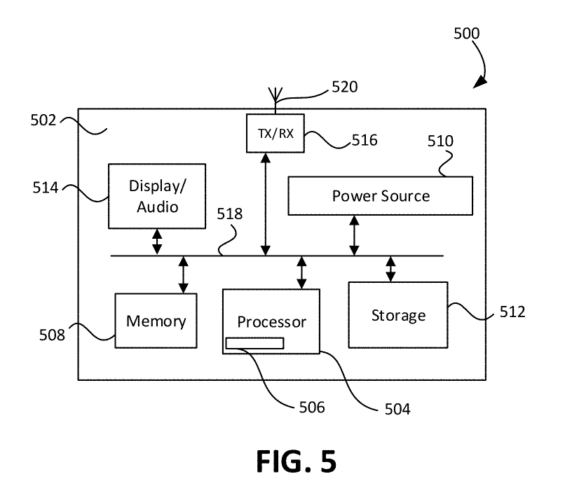

With reference to FIG. 5, mobile device 102 may include a printed circuit board (“PCB”) 502 that has a digital processor 504 for processing electrical signals produced by any of the components and software of 102. Digital processor 504 may further run software 506 for executing the processes, methods, and the like of icon arranging system 100. Software 506 contains necessary algorithms to analyze, interpret, and list the original locations of application icons 108 and related screens 105. It may also do so for the re-arranged application icons 108.

Also, mobile device 102 may include a memory system 508 and a power source 510 (e.g., a battery or other power source). Additionally, mobile device 102 may include a storage device 512, which may along with memory system 508 store all data associated with icon arranging system 100, including database 200.

Further, 102 may include an audio and/or video unit 514 for emitting audio signals and displaying video signals. Preferably, computer 514 may include a data transceiver/receiver (transceiver TX/RX) component 516 for transmitting data to and/or receiving data from one or more electronic devices, manufacturers mobile phone application stores, and the like. A computer architecture pathway, referred to herein as bus 518, enables all elements/components of icon arranging system 100 to communicate with each other and other electronic devices as described herein. Also, mobile device 102 may include an antenna 520 in communication with TX/RX component 516.

It is understood that icon arranging system 100 can be configured for communication with a plurality of external devices, including a wide variety of different types and configurations of electronic devices via wired or wireless links as described above relative to FIG. 5. Additionally, TX/RX component 516 and antenna 520 of icon arranging system 100 may be configured for a plurality of different types of electronic communication.

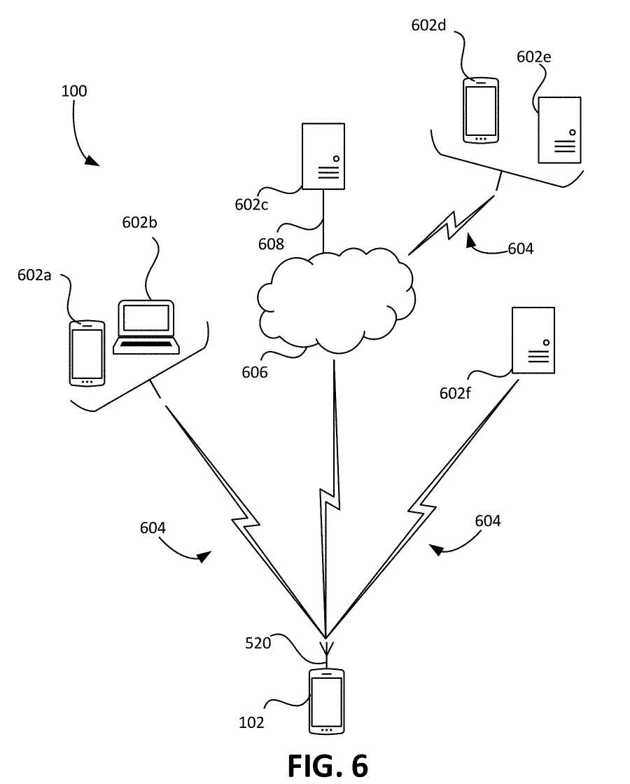

With reference now to FIG. 6, icon arranging system 100 may incorporate network and/or wireless connectivity that enables icon arranging system 100 to communicate with other devices, computers, servers, etc. for transmitting stored types of application icons 108, arrangements of application icons 108, and the like by other users, such that a particular use can use icon arranging system 100 to display application icons 108 in the exact same locations and screens 105 as another user, such as a celebrity, athlete, industry icon, C-Suite, executives, and the like.

In one embodiment, via wired communication link 608 or wireless communication link 604, icon arranging system 100 may communicate via links to one or more external devices, such as other mobile devices 602a, computing devices 602b, servers 602c, mobile devices 602d, servers 602e, and/or servers 602f (collectively external devices 602). Although FIG. 6 shows a few specific arrangements of the communication links and external devices 602, icon arranging system 100 may include any combination and arrangement of such communication links, such as wireless communication link 604 and wired communication link 608, as would be known to those skilled in the art. Through these communication links and external devices, users of icon arranging system 100 may download and share other mobile device 102 icon arrangements, such as from a mobile phone manufacturers application store, such as iTunes and the like for a fee typically.

In one embodiment, icon arranging system 100 may be in communication with mobile device 602a and/or computing device 602b via wireless communication link 604 for transmitting analyses, digital images, data, etc. to these external devices 602. In another embodiment, icon arranging system 100 may be in communication with the cloud or internet 606 that is further in communication with one or more of external devices 602, such as a server 602c. Although the communication link is shown as wired communication link 608, this communication link may also be wireless communication link 604 as one skilled in the art would know. Additionally, internet 606 may be in communication with one or more of external devices 602 via another wireless communication link 604 to communicate particular and/or stored icon arrangements as described herein.

Also, known servers, such as server 602f, may be in wireless communication directly with icon arranging system 100 via wireless communication link 604, for example. Additionally, any of the shown communication links may be either wired or wireless as would be known to those skilled in the art.

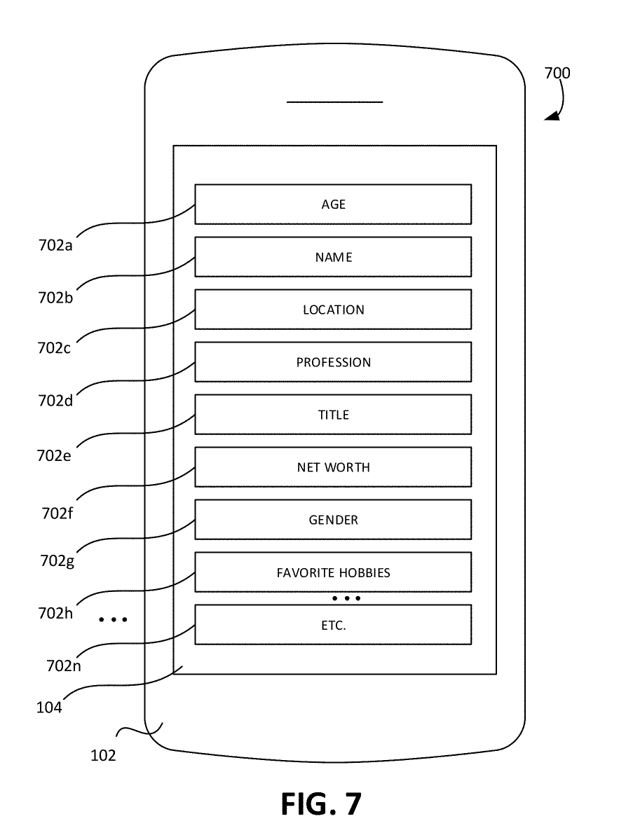

Turning now to FIG. 7, an embodiment of a graphical user interface 700 displayed on visual display 104 of mobile device 102 is shown and described herein. In one embodiment, graphical user interface 700 may display one or more demographic input data fields for a user to establish their demographics for ultimately being part of a data pool for providing users of icon arranging system 100 preferred application icons arrangements particular to a certain demographic. For example, graphical user interface 700 may include an age 702a data field for entering the age of a particular user. Also, graphical user interface 700 may include a name data field 702b for entering the name of a user, although this information may be restricted within icon arranging system 100. Additionally, graphical user interface 700 may include a location data field 702c for entering the location of a particular user.

In one embodiment, graphical user interface 700 may include a profession data 702d for entering the profession of the particular user such that icon arranging system 100 can compile all other users with similar professions for providing other users who seek to replicate similar application icons the data to do so. Graphical user interface 700 may also include a title data field 702e for determining the title of a particular user, which as with profession data field 702d, may be in a similar fashion. Other data fields, such as net worth data field 702f, gender data field 702g, favorite hobbies data field 702h, and etc., data field 702n may in addition to other data fields be presented to a user of icon arranging system 100 for inputting relevant data to reflect their status and what applications, application icons, and arrangements of them for use by other users.

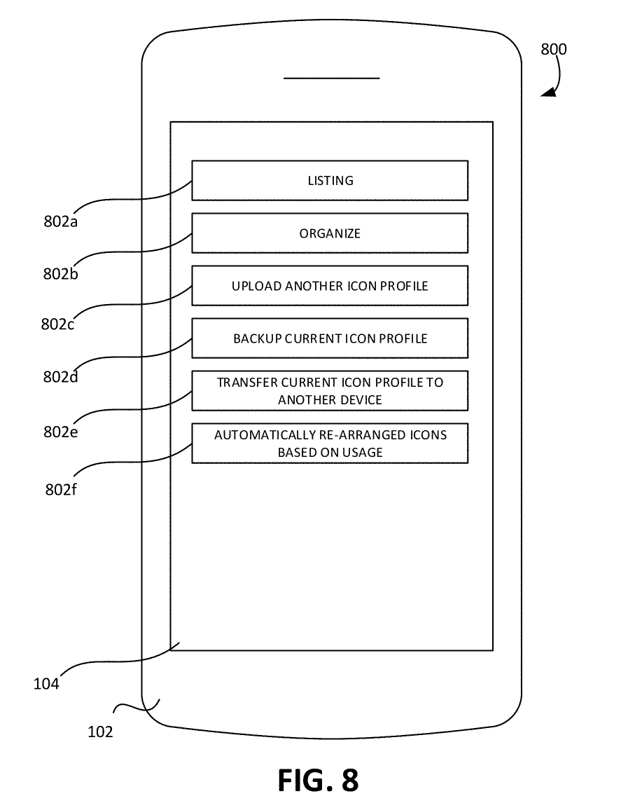

Turning now to FIG. 8, another graphical user interface 800 is shown and now described. Graphical user interface 800 may include command buttons of icon arranging system 100, such as listing button 802a whereby activation of it lists and displays application icons, such as shown in FIGS. 1 and 4, to visual display 104 of mobile device 102 to a user. Additionally, graphical user interface 800 may present an organize button 802b that presents a newly arranged display of application icons based on revisions made to database 200, for example. Graphical user interface 800 may include an upload another icon profile button 802c for uploading the profile of the user or of another user of the system. Graphical user interface may include a backup current icon profile button 802d for backing up a current icon profile. Graphical user interface may also include a transfer current icon profile to another device button 802e for quickly sharing or transferring a current icon profile to another device. Graphical user interface 200 may also include an automatically re-arranged icons based on usage button 802f for re-arranging the application icons based on the frequency or usage of the particular mobile device.

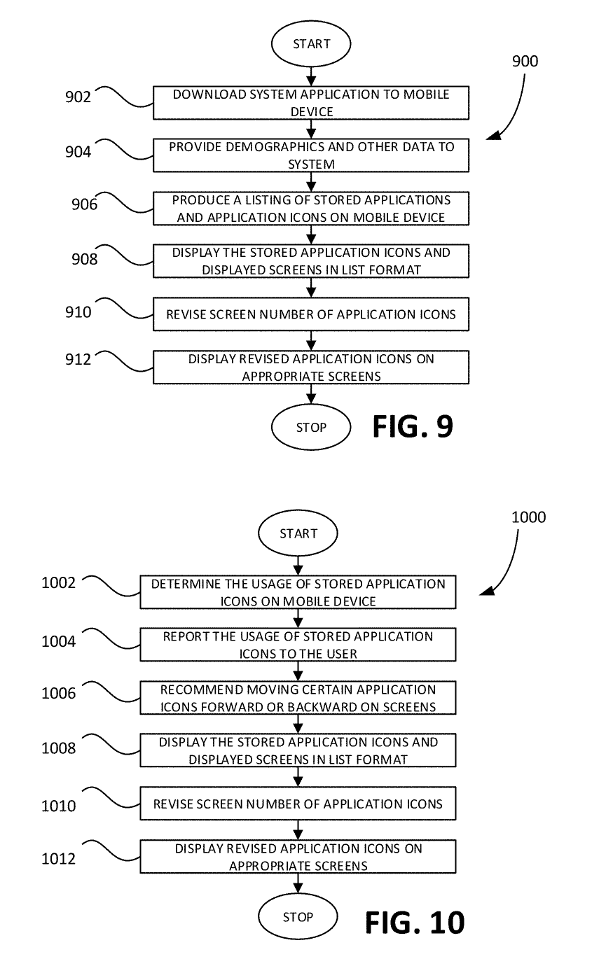

Referring now to FIG. 9, an embodiment of a method for detecting changes in a physical environment 900 is shown and described. In step 902, a user may use their mobile device 102 and connect with an online mobile device application store, such as Apple iTunes or Google Store and download the application icon arranging system 100. This step may also include agreeing to the end user license agreement, as some information relative to FIG. 7 may be obtained by icon arranging system 100 for purposes of offering similarly arranged application icons as those a user desires to have. This step may also include logging into the icon arranging system 100 application once it's loaded on the user's mobile device 102.

In step 904, demographics, profile, and other information relative to a particular user of icon arranging system 100 may be collected by icon arranging system 100 by inquiring through one or more data fields 702a-702n as described above relative to FIG. 7. In step 906, a user may click on or initiate a “listings” button as displayed on mobile device 102 by icon arranging system 100 listing all applications, application icons, etc., installed on mobile device 102 for presenting to the user, such as shown in database 200. In step 908, icon arranging system 100 may display those application icons to visual display 104 of mobile device 102 in a list, spreadsheet, and/or database format.

In step 910, a user may change screen numbers of those application icons 108 that they wish to be on a different screen, such as changing the number “3” to “1” for a particular application icon. In step 910, the user may click on organize button 802b to organize or re-arrange the application icons based on the edited database 200.

Referring now to FIG. 10, a method 1000 for arranging application icons based on usage on a display 104 of a mobile device 102 is shown and described. In step 1002, icon arranging system 100 may determine the usage of each application icons 108 on mobile device 102 by the number of times a user opens up particular application icons 108, for example. The frequency of usage may then be categorized, prioritized and the like, such as described above. In one aspect, a usage number may be assigned to each particular application icon 108, for example, those numbers or numeral values as shown in frequency column 202f. In step 1004, icon arranging system 100 may report the usage or frequency as described herein to a user of mobile device 102, for instance.

In step 1006, icon arranging system 100 may recommend to the user to move certain application icons 108 to another screen 105 than its current location or position that more accurately reflects its usage for better ease of use by the user of mobile device 102. This method then proactively can recommend such relocation of application icons 108 to a user so that they are more easily accessible according to their usage.

In step 1008, icon arranging system 100 may then display the stored application icons 108 and the displayed screens 105 in list format, such as that shown in FIGS. 2A-2B and/or 3A-3B, for example. This particular step may be optional per a user's preference. In step 1010, icon arranging system 100 may revise the locations of the application icons 108 based on the recommendations. In one aspect, this step may be undertaken by presenting the user with a “rearrange” button or organize button 802b and the like as described herein. In step 1012, icon arranging system 100 may then display the application icons 108 in the recommended locations to the user of mobile device 102.

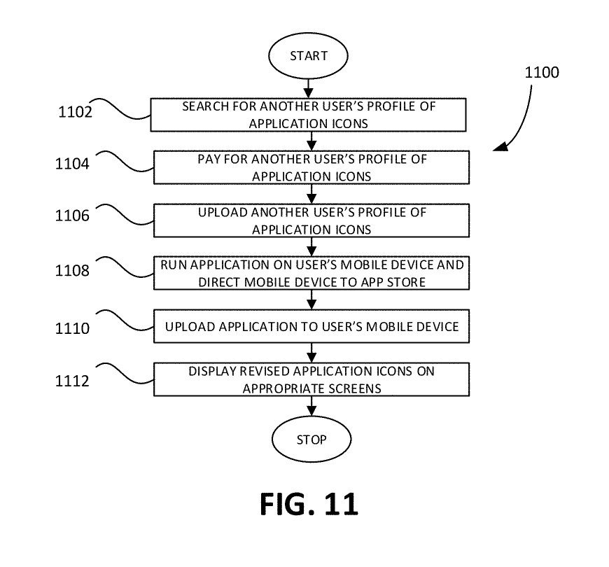

Turning now to FIG. 11, a method 1100 for uploading desired profiles of other users is shown and described. This method may be used for uploading application profiles of other users, for example. In one instance, a particular user may use icon arranging system 100 to find a particular profile of application icons 108 that may be of particular interest to the user. For example, a marketing executive may wish to arrange their mobile device 102 with application icons 108 and their relative locations on visual display 104 of mobile device 102 of other successful marketing executives. In another example, a user may wish to have the same or similar application icons 108 and have them arranged the same as a celebrity, athlete, famous person, etc.

In step 1102, a user of icon arranging system 100 may search for a particular job category, title, celebrity name, etc. In this step, in response to the search, icon arranging system 100 may return one or more potential answers to the inquiry. In step 1104, the user may pay for the profile at icon arranging system 100 for the authorization to upload the selected application icons 108 profile to mobile device 102. In step 1106, icon arranging system 100 may then upload the selected profile. In step 1108, mobile device 102 may run the application program and inquire if the user would like to be directed to a mobile device application store, such as iTunes, and the like. This step may include displaying to the user those application icons 108 from the uploaded profile that aren't currently on the mobile device 102.

In step 1110, the user may upload those applications from the application store. This step may include icon arranging system 100 then arranging the uploaded application icons 108 with any application icons 108 already stored on the mobile device 102 to then display them according to the uploaded application profile. In step 1112, icon arranging system 100 may re-arrange icons 108 that were already stored and those icons 108 uploaded from the application store and then present them similarly and/or identically to those from the uploaded other user's application profile.

While this invention has been described with reference to illustrative embodiments, this description is not intended to be construed in a limiting sense. Various modifications and combinations of the illustrative embodiments as well as other embodiments of the invention will be apparent to persons skilled in the art upon reference to the description. It is, therefore, intended that the appended claims encompass any such modifications or embodiments.

What is claimed is:

1. A method for arranging application icons on mobile devices, the method comprising:
searching the mobile devices of two or more users for stored application icons and their associated screen numbers that they appear on the two or more users' mobile devices;
presenting a first list of stored application icons and their associated screen numbers as they appear on the two or more users' mobile devices;
receiving input from the two or more users to revise the screen number of one or more application icons to create a second list of stored application icons; and
displaying the stored application icons on the two or more users' mobile devices according to the second list.

2. The method of claim 1, further comprising:
collecting from the two or more users at least one of a respective user's age, name, location, profession, title, net worth, gender, and favorite hobbies for creating two or more application icon profiles of the two or more users.

3. The method of claim 2, further comprising:
storing all the one or more application icon profiles for searching and uploading to the two or more users' mobile devices.

4. The method of claim 3, further comprising:
searching the stored one or more application icon profiles according to a particular user's search criteria for selecting one or more of the one or more application icon profiles.

5. The method of claim 4, further comprising:
uploading the selected one or more of the one or more application icon profiles to the particular user's mobile device.

6. A system for arranging application icons on mobile devices, the system comprising:
at least one processor;
a memory connected to the at least one processor; and
a module that when loaded into the at least one processor causes the at least one processor to:
search the mobile devices for all applications, application icons, and the numbered screen on which the application icons appear on the mobile devices;
list all applications, application icons, and their respective numbered screens; and
accept input from a user to change the numbered screens on the applications and application icons that appear on the mobile devices.

7. The system of claim 6, wherein the module further causes the at least one processor to:
display the applications and application icons according to their changed numbered screens.

8. The system of claim 6, further comprising:
a transceiver coupled to the processor for communicating with an external device.

9. The system of claim 8, wherein the transceiver is a wireless transceiver.

10. A method for arranging application icons on mobile devices, the method comprising:
searching the mobile devices of two or more users for stored applications, icons associated with the stored applications, and screen numbers associated with the icons as the icons appear on the two or more users' mobile devices;
determining the frequency of use by the users of their stored applications and associated icons relative to their screen numbers; and
displaying to the two or more users recommendations of those stored applications and associated icons that should be moved to a screen closer to a home page and those stored application icons that should be moved to a screen farther from a home page based on the frequency of use.

11. The system of claim 10, wherein the determining the frequency of usage comprises:
calculating the percentage of the frequency of use of a stored application to the frequency of use of the stored applications.

12. The system of claim 11, wherein the determining the frequency of usage comprises:
determining the number of times the two or more users have opened the stored application.

13. (canceled)

14. The system of claim 11, wherein the determining the frequency of usage comprises:
ranking the one or more stored applications based on the frequency of usage of the two or more users and/or devices.

15. The system of claim 11, wherein the determining the frequency of usage comprises:
displaying the one or more stored applications on relevant screens according to their frequency of usage.
